(19) United States
(12) Patent Application Publication
(10) Pub. No.: US 2012/0143107 A1
(43) Pub. Date: Jun. 7, 2012

(54) DEVICE AND METHOD FOR TREATING NOCTURIA

(76) Inventor: Ernest J. Henley, Houston, TX (US)

(21) Appl. No.: 12/959,951

(22) Filed: Dec. 3, 2010

(51) Int. Cl. A61H 1/00

(52) U.S. Cl. 601/53

(57) ABSTRACT

A device and method for treating nocturia that transmits a vibratory signal into the lumbar region of a subject. The vibratory signal couples into the subject from a flexible medium, such as a visco-elastic foam, so that the vibratory signal has a dominant frequency. The flexible medium can be a bed mattress, a chair, a recliner, as well as a seat in a vehicle. A vibratory signal source is used to generate the vibratory signal, and can be an oscillating motor. The motor can mount on a membrane stretched across a surface of the flexible medium, or can be supported and held in contact with the flexible medium while on a stand.

### BACKGROUND

1. Field of Invention

The invention relates generally to the field of treating nocturia. More specifically, the present invention relates to a method and apparatus for propagating a mechanical vibratory signal to the sacral nerve of a subject. Yet more specifically, the present invention relates to a method and apparatus for transmitting a mechanical signal to the sacral nerve of a recumbent subject for a protracted period of time.

2. Description of Prior Art

Most people can sleep for six to eight hours without the sensing a need to urinate. People afflicted with nocturia though experience many episodes of an urgency to urinate throughout the night; whether or not an actual need to relieve their bladder actually exists. The frequent sleep disruptions of these individuals deprive them of needed rest to adequately function during normal waking hours. The cause of nocturia is typically of neurogenic origin rather than other conditions that can produce urinary frequency; such as an infection or an enlarged prostrate.

The sacral nerve, which runs from the lower spinal cord to the bladder, influences muscles that control the bladder. One treatment for nocturia involves applying electrical stimulation to the sacral nerve of a subject using a sacral nerve stimulator. Similar to a pacemaker, sacral nerve stimulators typically are self contained devices implanted subdural within the subject. An electrical signal lead from the sacral nerve stimulator connects to the sacral nerve of the subject. A power source, typically a battery, in the sacral nerve stimulator provides an electrical signal that is transmitted through the lead and to the sacral nerve. The electrical signal is usually delivered to the nerve in the form of a pulse, and interrupts signals from the bladder to a subject's brain that convey a need to urinate. Other devices direct an electrical signal to one or more muscles for relaxing overactive muscles and contracting weaker ones. Experiments have been conducted both transcutaneously, and with treatment heads inserted into the rectums or vagina of the subject. In these experiments, the electrical frequencies used have been in the 10-75 Hertz region. The aforementioned devices though are invasive and require maintenance.

### SUMMARY OF INVENTION

Disclosed herein is a method and device for noninvasively treating nocturia. In an example embodiment the method includes providing a flexible medium that has a treatment surface and transmitting a vibratory signal into the medium that makes its way to the treatment surface and when the treatment surface contacts a lumbar region of a subject, the vibratory signal is transmitted to a sacral nerve in the subject to mute a bladder control signal in the sacral nerve. The treatment surface oscillates at a dominant single frequency within a designated location on the surface, placing the designated location against the subject transmits the vibratory signal into the subject. In an example embodiment, the flexible medium is a bed mattress having a visco-elastic foam, where the visco-elastic foam couples the vibratory signals into the subject. In an example embodiment, the single dominant frequency ranges from about 10 Hertz to about 50 Hertz. The single dominant frequency can range from about 13 Hertz to about 15 Hertz. The method may further include providing a source for the vibratory signal that includes an oscillating motor, where the vibratory signal is produced by operating the oscillating motor. The example method can further include positioning the vibration source on a side of the medium opposite the treatment surface and substantially across from the designated location. In yet another example embodiment, an adjustable frame can be provided for holding the oscillating motor in close contact with the medium. In an example embodiment, the vibratory signal when produced by the oscillating motor has more than one dominant frequency.

Also disclosed herein is a device for treating nocturia that includes a vibratory signal source and a flexible medium in contact with the vibratory signal source. The flexible medium can have a treatment surface with a designated location. In this embodiment of the device, when the designated location is put into contact with a lumbar region of a subject while the vibratory signal source produces a vibratory signal; the signal is transmitted into the flexible medium, the subject, and to a sacral nerve in the subject and mutes other signals in the sacral nerve. In an example embodiment, the flexible medium includes a visco-elastic foam. Optionally, the flexible medium can be a portion of a bed mattress. In an example embodiment, the designated location oscillates from about 10 Hz to about 50 Hz, and optionally can oscillate at about 13 Hz. In an example embodiment, the vibration source is selectively positioned on a side of the flexible medium opposite the treatment surface and directly from the lumbar region of the subject. In an example embodiment, the vibratory signal has a dominant single frequency when transmitted into the subject.

### BRIEF DESCRIPTION OF DRAWINGS

Some of the features and benefits of the present invention having been stated, others will become apparent as the description proceeds when taken in conjunction with the accompanying drawings, in which:

FIGS. 1A and 1B are respective a side perspective view and an end sectional view of an example embodiment a device for treating nocturia.

FIG. 2 is a side view of a vibration source.

FIG. 3 is a side partial sectional view of an alternate embodiment of the device of FIG. 1.

FIG. 4 is a side view of an alternate embodiment of the device of FIG. 1.

FIGS. 5A and 5B respectively illustrate sensor locations on a test device and levels of attenuation at distances away from a reference.

FIGS. 6A and 6B illustrate sensor locations on a test device with a subject and showing attenuation levels from a reference point on the test device.

FIGS. 7A and 7B contain power density plots for the respective vertical and horizontal axes of a vibration source.

FIGS. 8A through 8E show power density plots for the horizontal axis of a vibration device being loaded with the mattress.

FIGS. 9A through 9E show power density plots of a vibration source in the vertical axes while being loaded with the mattress.

FIGS. 10A and 10B show power density plots for respective horizontal and vertical axes of a shaker loaded with a mattress and a test subject.

FIGS. 11A and 11B are power density plots of horizontal and vertical axes of a shaker loaded with a mattress and a test subject.

FIGS. 12A through 12E are frequency response function plots of the vertical axes of a shaker loaded with a mattress.

FIGS. 13A through 13E are coherence plots, respectively, for the data plots of FIGS. 12A through 12E.

FIGS. 14A through 14E are frequency response function plots for the Y axis of a treatment surface and taken at locations along the treatment surface.

FIGS. 15A through 15E are coherence plots, respectively, for the data plotted in FIGS. 4A, 14A through 14E.

FIGS. 16A and 16B are frequency response function plots taken on a treatment surface having a subject.

FIGS. 17A and 17B are coherence plots of the data plotted in FIGS. 16A and 16B.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The present invention will now be described more fully hereinafter with reference to the accompanying drawings in which embodiments of the invention are shown. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

It is to be understood that the invention is not limited to the exact details of construction, operation, exact materials, or embodiments shown and described, as modifications and equivalents will be apparent to one skilled in the art. In the drawings and specification, there have been disclosed illustrative embodiments of the invention and, although specific terms are employed, they are used in a generic and descriptive sense only and not for the purpose of limitation.

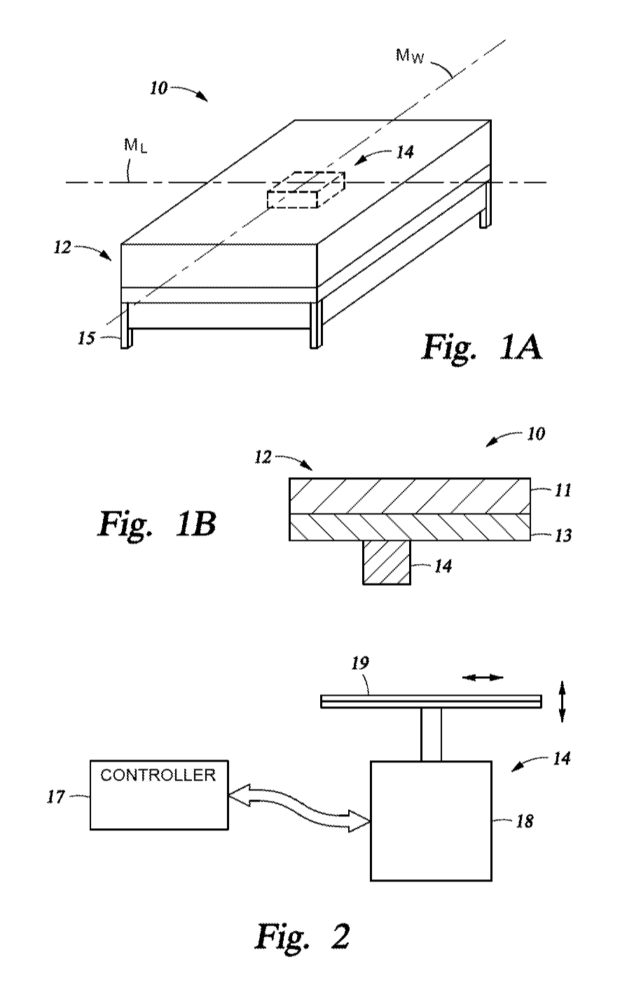

Referring now to FIG. 1A, an example embodiment of a treatment system 10 is shown in a side perspective view. In the illustration of FIG. 1, the treatment system 10 includes a generally rectangular medium 12 coupled with a vibration source 14 shown in dashed outline. In the embodiment of FIG. 1, the vibration source 14 is coupled to a lower surface of the medium 12 and generates vibratory signals that couple into the medium 12 and propagate up to the upper surface of the medium 12. In an alternate embodiment, the vibration source 14 could be in (partially or wholly) the medium 12. In an example embodiment the medium 12 is a mattress and can reside on a bed frame 15, that can be a simple trolley. The bottom of the mattress can be suspended in the frame by slats or a wooden board (not shown).

Referring now to FIG. 1B, the treatment system 10 of FIG. 1A is provided in a side sectional view that shows the vibration source 14 in contact with a side of the medium 12. In this embodiment, the medium 12 includes a mattress 11, that can be wholly or partly made from the foam materials described below. The mattress 11 is shown disposed on a support 13, that in an example embodiment is a box spring and includes springs (not shown) for resiliently supporting the mattress 11. Also provided in FIG. 1B is that the vibration source 14 is offset and not centered with the centerline of the length of the medium 12, which is represented as line M_{L} (FIG. 1A) As will be described in further detail below, the vibration source 14 can be selectively positioned at locations along the length of the medium 12 or directing a vibration signal to a subject for treatment. Referring back to FIG. 1A, the vibration source 14 is illustrated at the center of the width of the medium 12, designated by line M_{W}. The selective positioning of the vibration source 14 provides placement of the vibration source 14 at any point along the width or length of the medium 12, and is not restricted to the locations depicted in the figures. Selective positioning of the vibrator along the length of the bed is possible and can be achieved by drilling holes in the frame 15 supporting the medium 12, or by appropriate spacing of slats (not shown) supporting the medium 12 (if supported by slats instead of a solid sheet of wood). In an example embodiment, the vibration source 14 is positioned at a location which is about two-thirds the length of M_{L}.

Referring now to FIG. 2, an example embodiment of the vibration source 14 is shown having motor 18 coupled on an upper end to a detachable plate 19, where the plate 19 can be as large as one square foot. The motor 18 reciprocatingly motivates the plate 19 and the vibration source 14 is disposed proximate the medium 12 so that the reciprocating motion of the plate 19 causes contact with the medium 12. The contact can occur on a lower or bottom surface of the medium 12. The contact between the plates 19 and medium 12 imparts a vibratory signal in the medium 12 that is transmitted through the medium 12. The vibration source 14 can be chosen from devices used for industrial or domestic use: such as an electric motor (mechanical), pneumatic, or electromagnetic. A controller 17 may be included for controlling the force and vibration frequency of the vibration source 14. The reciprocating motion of the plate 19, illustrated by the double headed arrows, can be directed away from/towards the motor 18, lateral to the motor 18, circular, helical, or combinations thereof.

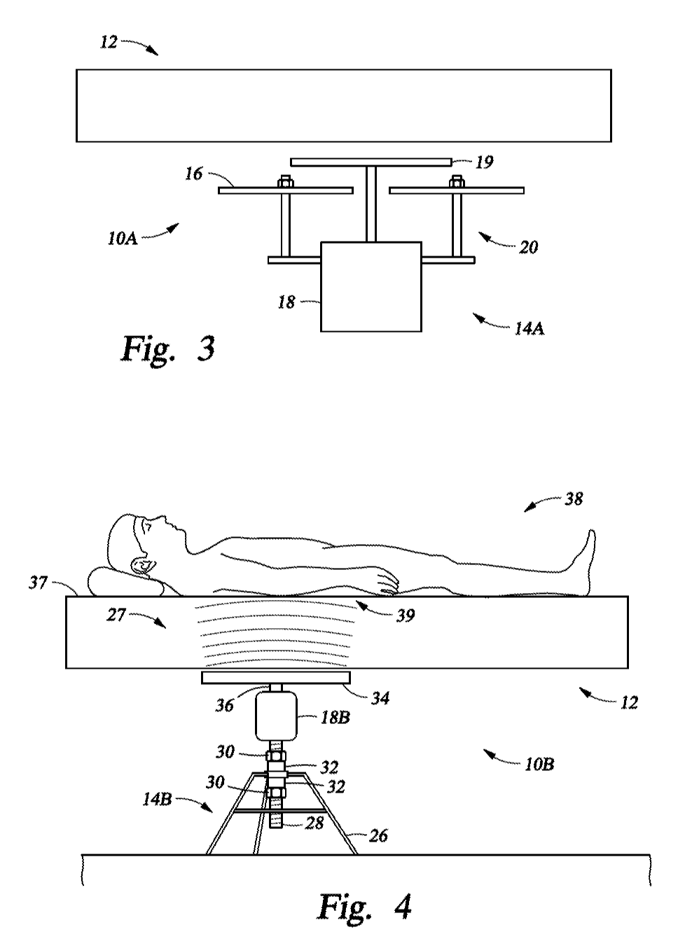

FIG. 3 illustrates an alternate embodiment of a treatment system 10A shown in a side partial sectional and exploded view. In the example embodiment of FIG. 3, the vibration source 14A is illustrated separate from the medium 12 for clarity. However, when the embodiment of FIG. 3 is in operation, the upper end of the vibration source 14A would be mounted onto the bottom of the medium 12. In the example embodiment of FIG. 3, the vibration source 14A is mounted to the medium 12 by coupling to a planar membrane 16 attached to the bottom of the medium 12, or the bottom of the springs (13) if the springs and flexible material (11) are a single unit. In an example embodiment, the membrane 16 is a sheet of wood or slats for supporting the medium 12. Optionally, an opening may be formed through the wood sheet for inclusion of the vibration system 14A. The vibrating force generated by the vibration source 14A of FIG. 3 is transmitted to the medium 12 via a support 20 that couples the vibration source 14A to the membrane 16. The support 20 can have rod-like lugs 22 that mount to a frame on the motor 18 and on an upper end bolt to the plate 19 shown disposed on a side of the membrane 16 opposite from the motor 18. In an alternate example embodiment the membrane 16 may be made of any woven material such as a sheet-like cloth, as well as a screen woven from metal members. In this configuration it is advisable to support the vibration source 14 with belting attached to the slats or sheet of wood. In an example embodiment, the motor 18 can be asymmetrically weighted so that upon rotation an oscillatory force is generated that is transmitted to the medium 12. Other examples of vibrations sources 14 include electromagnetic vibrators, that in one embodiment include a core disposed within a magnetic field, wherein oscillating the magnetic field, such as by a change in polarity, vibrates the core. Examples of core material include metal and may specifically include ferrous metals.

Referring now to FIG. 4, another alternate embodiment of a treatment system 10B can be as shown in a side view. Here, a frame 26 is shown for supporting a motor 18B to deliver a vibration signal 27 into the medium 12. The frame 26 is shown having a series of upwardly extending legs and cross-members that connect the legs. An elongate fastener 28 is shown having an end coupled with a lower end of the motor 18B, and another end mounted onto a cross-member of the frame 26 for supporting the motor 18B in place. In the embodiment of FIG. 4, lock nuts 30 secure the fastener 28 onto the frame 26. Optional vibration dampeners 32 are shown wedged between the lock nuts 30 and frame 26, wherein the dampeners may be made of an elastomer for damping vibration or eliminating harmonics within the frame 26. A plate 34 is shown mounted on an upper end of the motor 18B on an upper extension 36. The plate 34 contacts a lower surface of the medium 12; by operating the oscillating motor 18B, that in turn accelerates the plate 34 in a reciprocating motion against the medium 12, forms vibrations signals 27 through the medium 12. The signals 27 can be transmitted to a desired location on the subject 38 by strategically situating the vibration source 14B.

In an example embodiment of FIG. 4, the medium 12 is a mattress having a treatment surface 37 on a side opposite where the medium 12 is contacted by the plate 34. A subject 38 is shown recumbent on the medium 12 and strategically located so the signals 27 contact the subject 38 within a lumbar region of the subject 38. Moreover, the vibrating signal 27 transmits into the subject 38 and propagates to the sacral nerve (not shown) of the subject 38 thereby masking or muting signals in the nerve that may travel between the bladder and brain of the subject 38. Accordingly, the vibratory vibrating signal 27 must be of sufficient magnitude when reaching the treatment surface 37 to mute the signals from the bladder and in the sacral nerve. In examples incorporating the medium 12 of FIG. 1B, the vibrating signal 27 also travels through the support 13, across the interface between the support 13 and mattress 11, and to the treatment surface 37. By directing a vibratory signal 27, that is transmitted transdermally to a subject so that the signal 27 travels into the sacral nerve of a subject 38, the subject 38 can experience relief from nocturia. Optionally, the signal 27 can be continuously directed into the subject 38 while the subject 38 is in contact with the treatment system 10. In an example embodiment, vibratory signals 27 are generated and directed to the subject 38 during a protracted period of time, where the protracted period of time exceeds an hour and having a duration substantially the same as the time the subject 38 is in a state of suspended consciousness, either completely or partially. A rest cycle for a subject 38 can be the time the consciousness of the subject 38 is suspended. Examples of suspended consciousness include meditation, sleep, sedation, anesthesia, and the like.

The medium 12 can include a material made from an open-cell visco-elastic foam, which in an example embodiment, is referred to as a memory foam. Optionally, the foam may be an open-cell urethane-ether foam, a closed-cell foam, such as a closed-cell ethylene-ether/dylene-polystyrene foam. Example embodiments of the visco-elastic foam have densities that range from about 4.5 to about 5.5 pounds per cubic foot and may have an indentation load deflection that ranges from about 12 pounds to about 15 pounds. The indentation load deflection is a measure of the load bearing capacity; this value is obtained by measuring the force required to compress a 4 inch thick foam sample to about 75% of the initial height of the foam. A 50 square inch circular indentor is generally used to compress the sample, where the sample is typically at least 24 square inches. In embodiments when the medium 12 includes a memory foam, the supple characteristic of the foam results in an interface between the foam and subject that substantially follows the outer surface of the subject. Moreover, because the foam compresses under a relatively small load, when the subject presses against or lies on the medium 12, the interface not only follows the contour of the side of the subject pressed against the treatment surface 37, but extends to surfaces lateral to the primary contact side. The substantial contact between the subject 38 and medium 12 and that the interface extends to lateral sides of the subject 38 increases signal coupling between the subject 38 and the medium 12 thereby increasing the transmission of the vibration signals 27 from the medium 12 to the subject 38 over that of traditional beds or seats that do not result in the close fitting interface described herein. Alternatively, the medium 12 can include a one or more of the embodiments of the foam described above

### Example

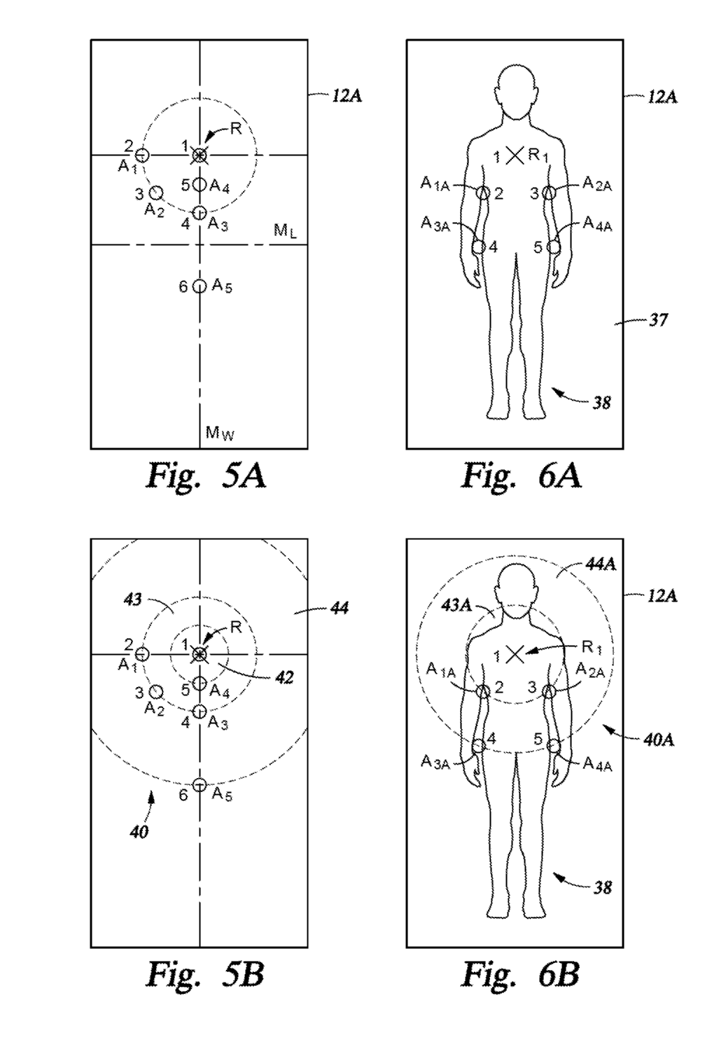

In a non-limiting example of use, a test medium was subjected to a vibratory signal generated by a VIBCO Model SPRT-60 vibrator and transmitted on a lower surface of a TEMPUR-PEDIC® “Cloud” memory foam mattress. Test data was collected from accelerometers measuring acceleration in the oscillating motor and on locations on the upper or treating surface of the medium. Data was also collected with a 160 pound subject supinely positioning on the treating surface of the medium. FIG. 5A illustrates example locations of a reference point R and accelerometer locations A₁₋₅. The reference point R, which is on the lower surface of the medium, is shown roughly at the midline M_{W} of the width of the medium 12A, but offset from the midline M_{L} taken along the length of the medium 12A. Accelerometer A₁ is shown set about 12 inches from the reference and at about the same point along the line M_{W}. Accelerometer A₂ is offset about 12 inches from the reference in a direction offset from the line M_{W} and accelerometer A₁. Accelerometer A₃ is set about 12 inches from the reference and along the line M_{W}, accelerometer A₄ is about 6 inches from the reference and along the line M_{W}. A₅, also set along line M_{W}, is about 30 inches from the reference and on a side of accelerometer A₃ opposite from the reference.

Referring now to FIG. 5B, intensity regions 42, 43, 44 are provided that represent vertical vibrational intensity with respect to vibrational intensity at the upper surface of the plate 19 (FIG. 3). In the intensity region 42, which extends from the reference R up to location of accelerometer A₄, the relative intensity of vibration was measured to be about 0.77 of vibrational intensity at or the bottom of the springs (13) if the springs and flexible material (11) are a single unit. In the intensity region 43, which resembles an annular shape, the relative intensity of vibration was measured to be about 0.54 of vibrational intensity at the plate 19 (FIG. 3) surface. Intensity region 44, which was measured by accelerometer A₅, was found to be at a relative intensity of 0.34 of vibrational intensity at the plate 19 (FIG. 3) surface.

FIGS. 6A and 6B present similar results from that of FIGS. 5A and 5B, more specifically, the test medium 12A in FIG. 6A is shown with a subject set on the treatment surface 37 and accelerometers A_{1A}-A_{4A} set adjacent the trunk portion of the subject 38. By operating the vibration source 14 (FIGS. 1-4), acceleration measurements were taken with the accelerometers A_{1A}-A_{4A} to define the intensity regions 43A, 44A shown overlaid on the medium 12A of FIG. 6B. Intensity region 43A, which is a circular region that having a diameter at the reference and circumference that intersects locations of accelerometers A_{1A} and A_{2A} was shown to have a relative intensity of about 0.07 from that of the vibrator vertical intensity. Intensity region 44A extends from the outer periphery of intensity region 43A into a circle that passes through both accelerometers A_{3A} and A_{4A}. The relative intensity with an intensity region 44A was measured to be about 0.02 of that taken from the vibrator vertical intensity.

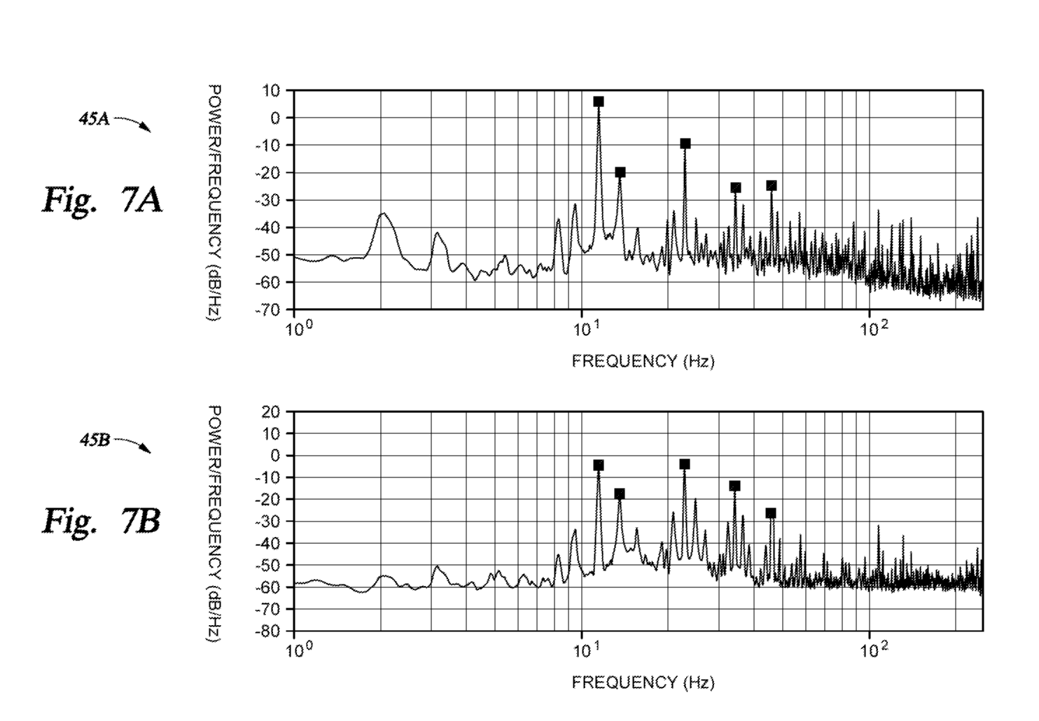

The vibrating source was operated while accelerometers positioned on a working surface of the source measured output from the source. Power density plots 45A, 45B are shown in FIGS. 7A and 7B, respectively, that represent the measured the power density in the horizontal and vertical axes of the vibration source. A number of harmonic peaks are shown in the plots 45A, 45B that range from frequencies at 11.58 Hz up to about 46.25 Hz. As such, the vibration source produces a vibrating signal with multiple transmission frequencies.

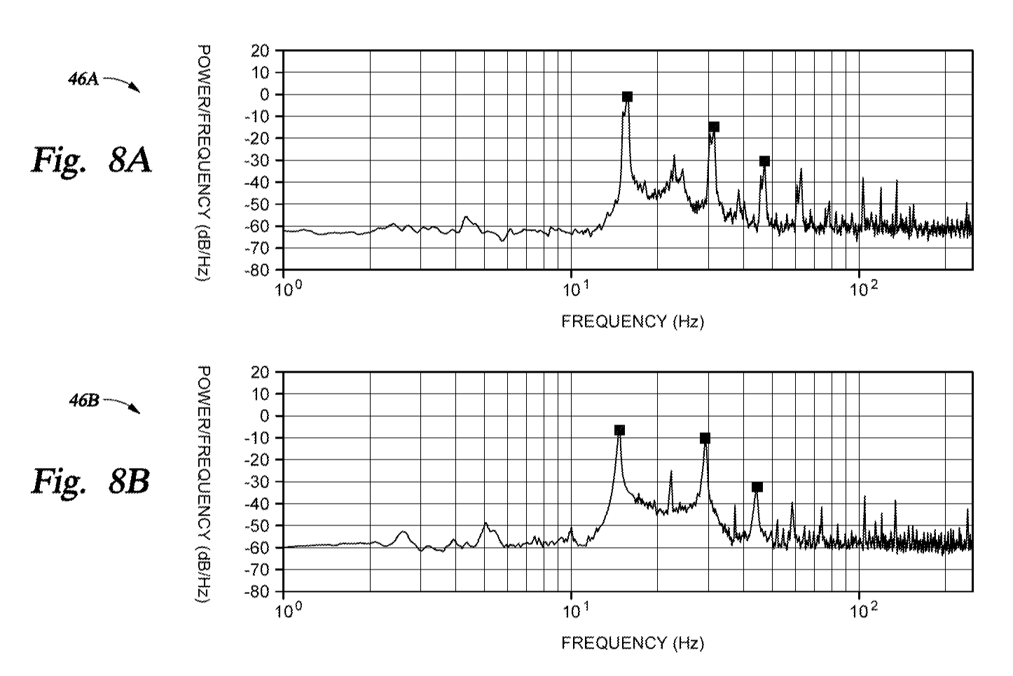

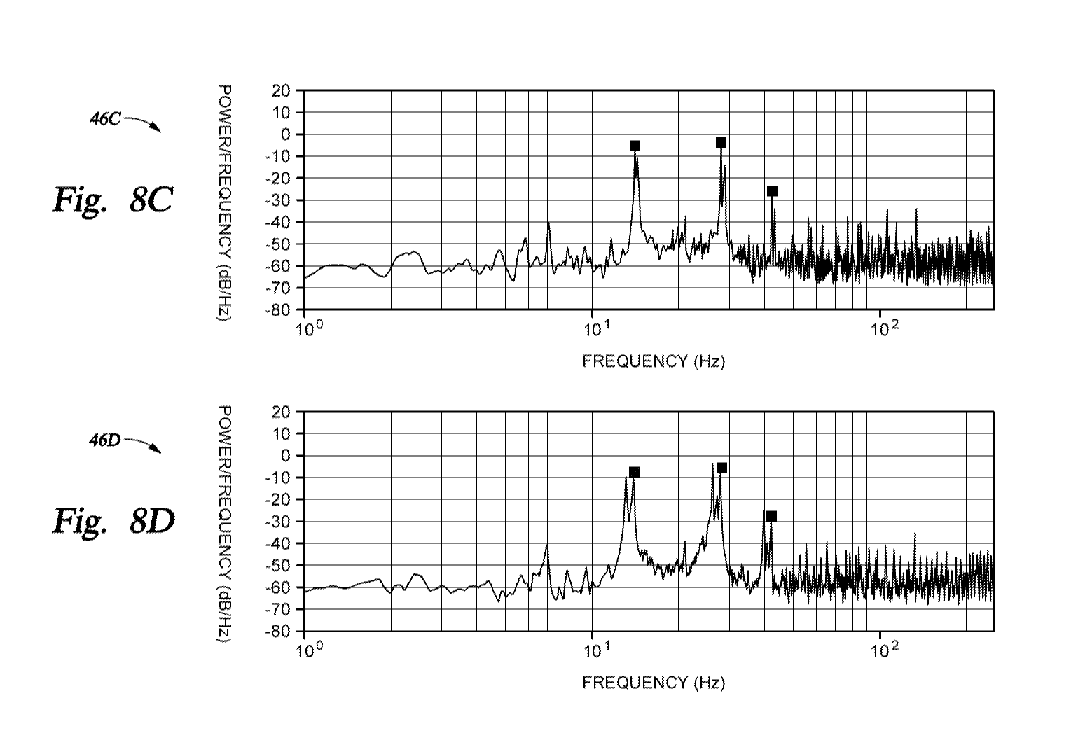

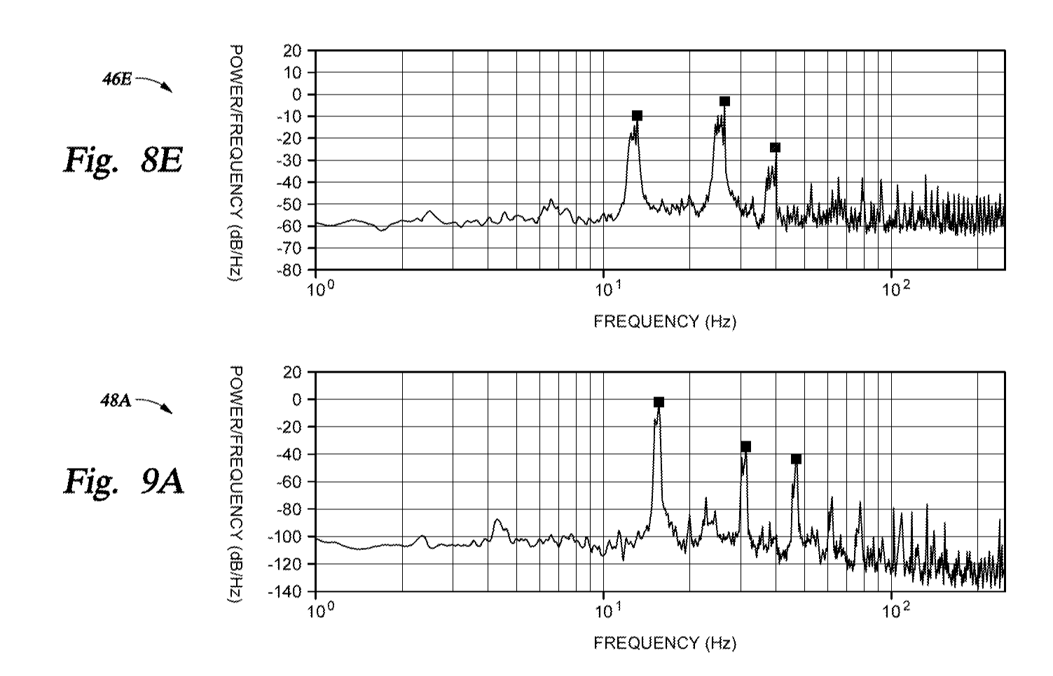

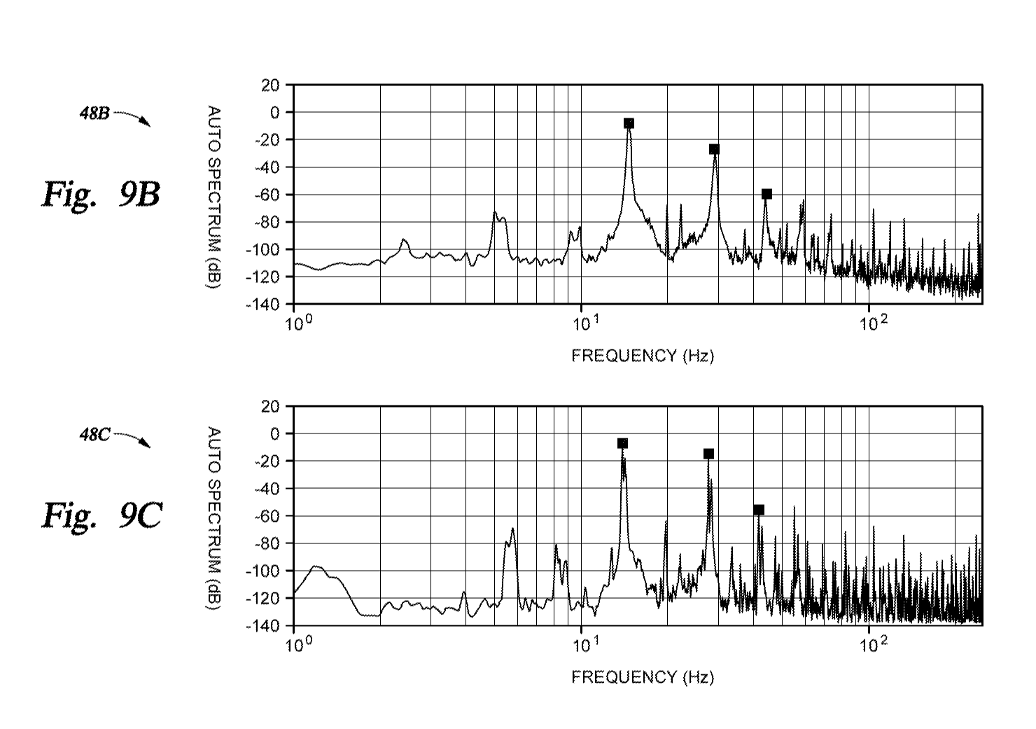

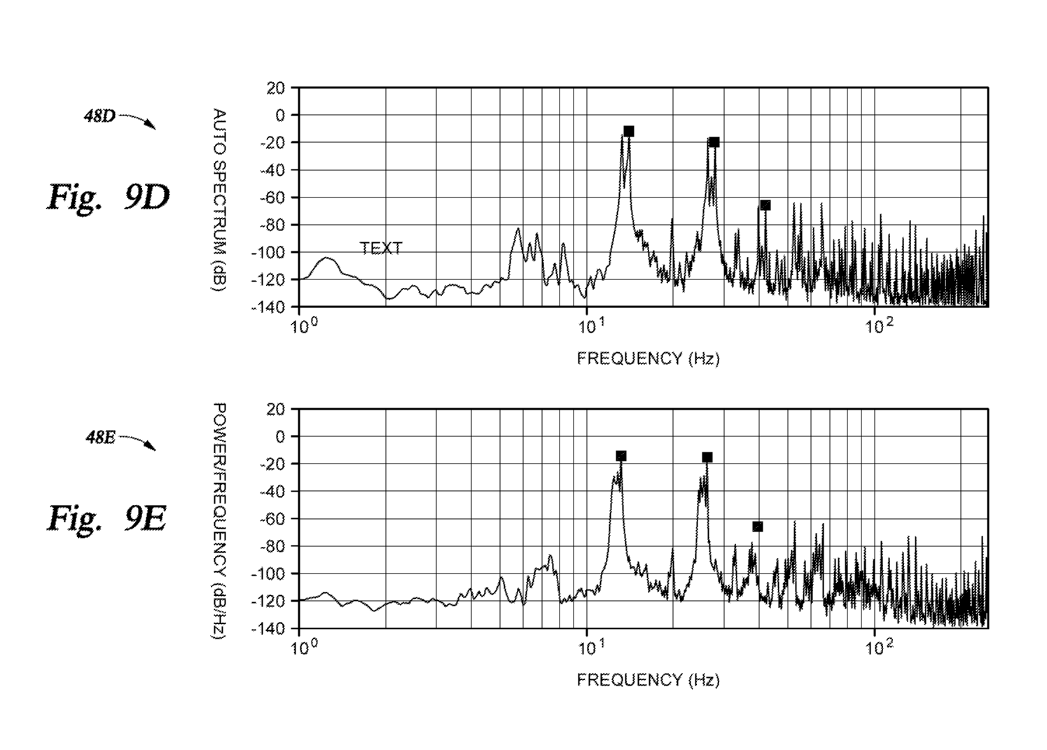

Shown in FIGS. 8A-8E and 9A-9E are power density plots 46A-46E, 48A-48E that represent frequency domain oscillation of the working side of the vibration source when it is loaded with a mattress, such as in the example illustrated in FIG. 4. The differences between FIGS. 8A-8E and 9A-9E are that the density plots 46a-46E are taken along a horizontal axis, whereas density plots 48A-48E used data measured along a vertical axis. Evident from these plots though are that the vibration source, although having a load of the mattress, continues to produce a signal with multiple dominant frequencies. These dominant frequencies are identified within each of the plots 46A-46E and 48A-48E.

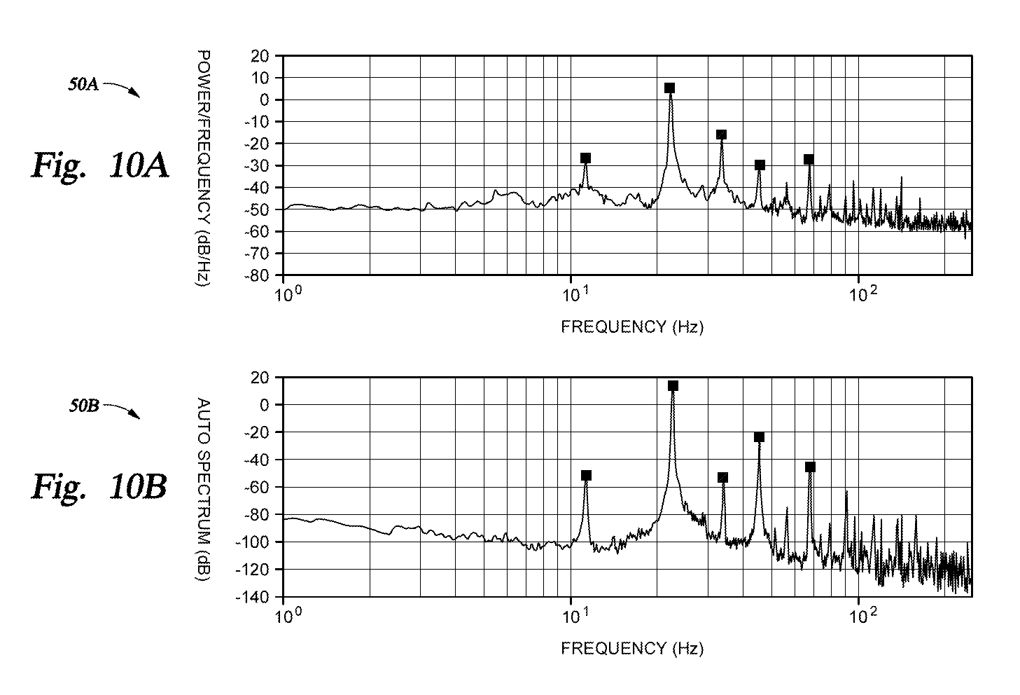

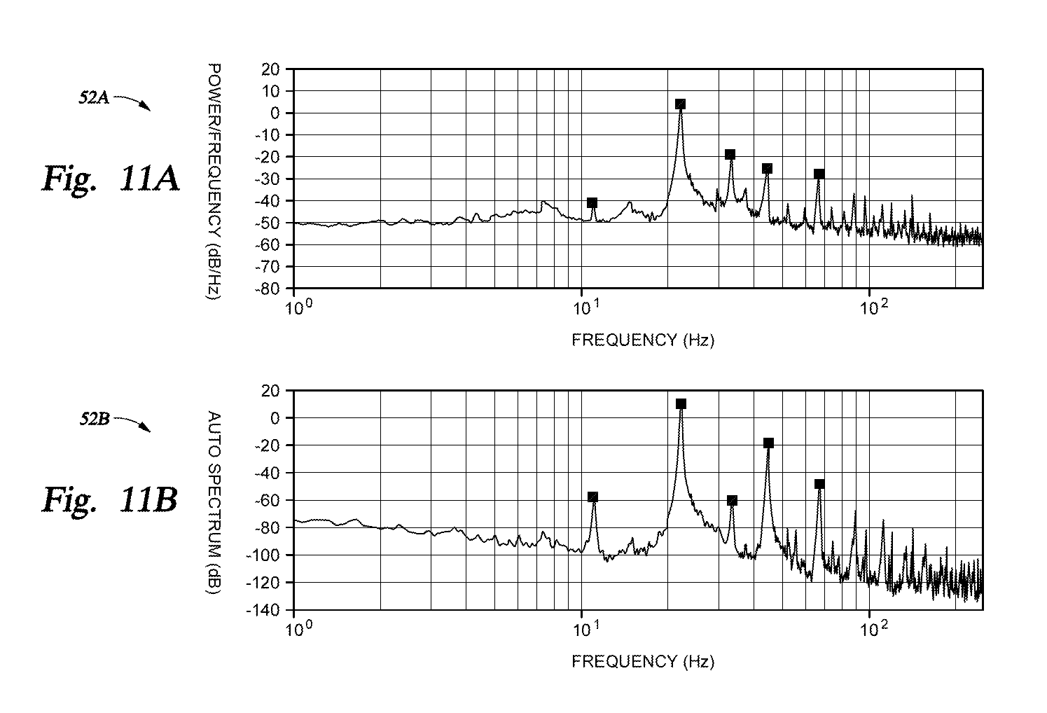

Shown in FIGS. 10A and 10B are power density plots 50A, 50B; plot 50A in FIG. 10A was formed from data measured on the power signal source along the horizontal axis, whereas the power density plot SOB in FIG. 10B was formed using data measured along the vertical axis and on the signal source. The density plots 52A, 52B provided in FIGS. 11A and 11B were generated in the same fashion as FIGS. 10A and 10B but in a separate test sequence. Also evident in FIGS. 10A, 10B, 11A, and 11B are the multiple dominant frequencies of the vibrating signal illustrated in each of these plots. As with FIGS. 8A-8E and 9A-9E, small square-shaped points are provided for identifying dominant frequencies.

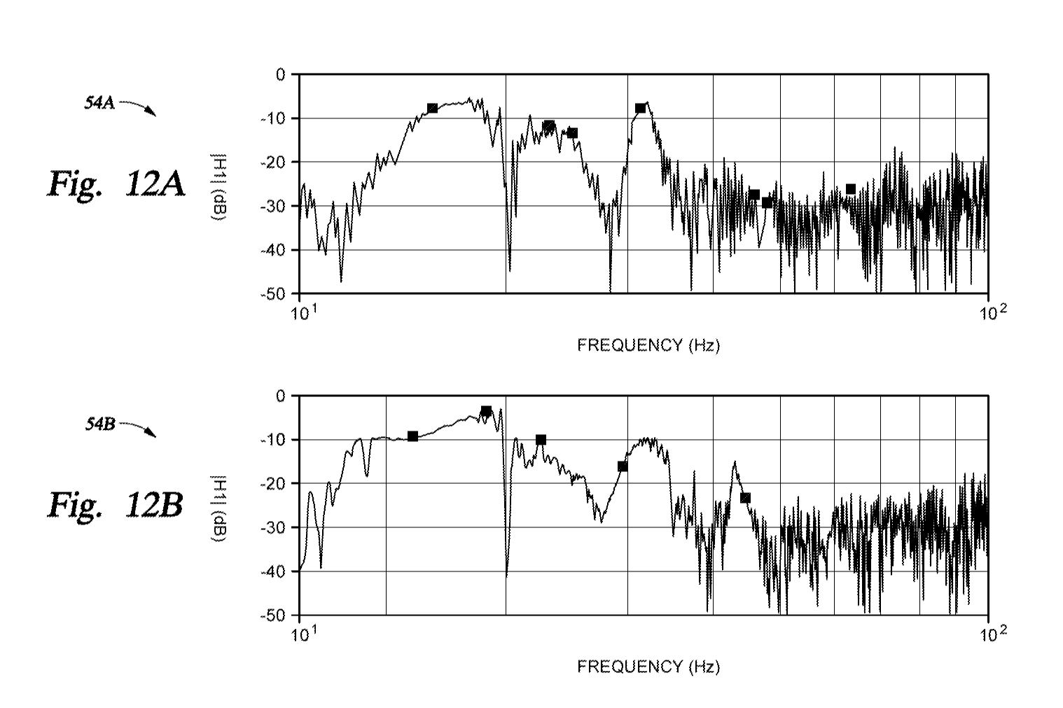

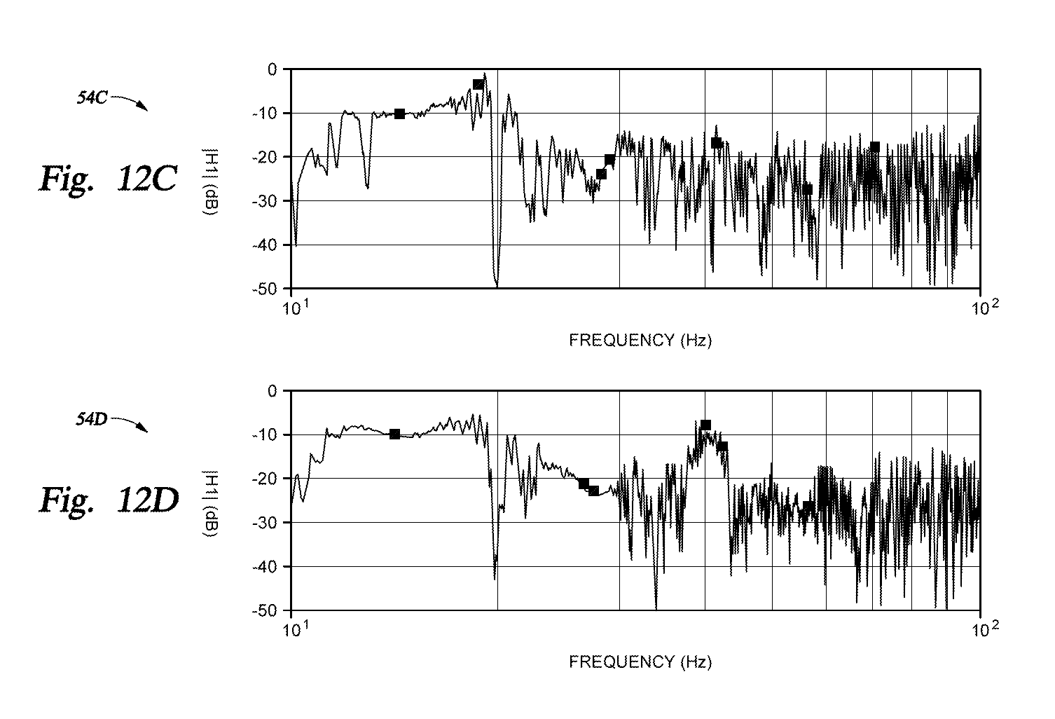

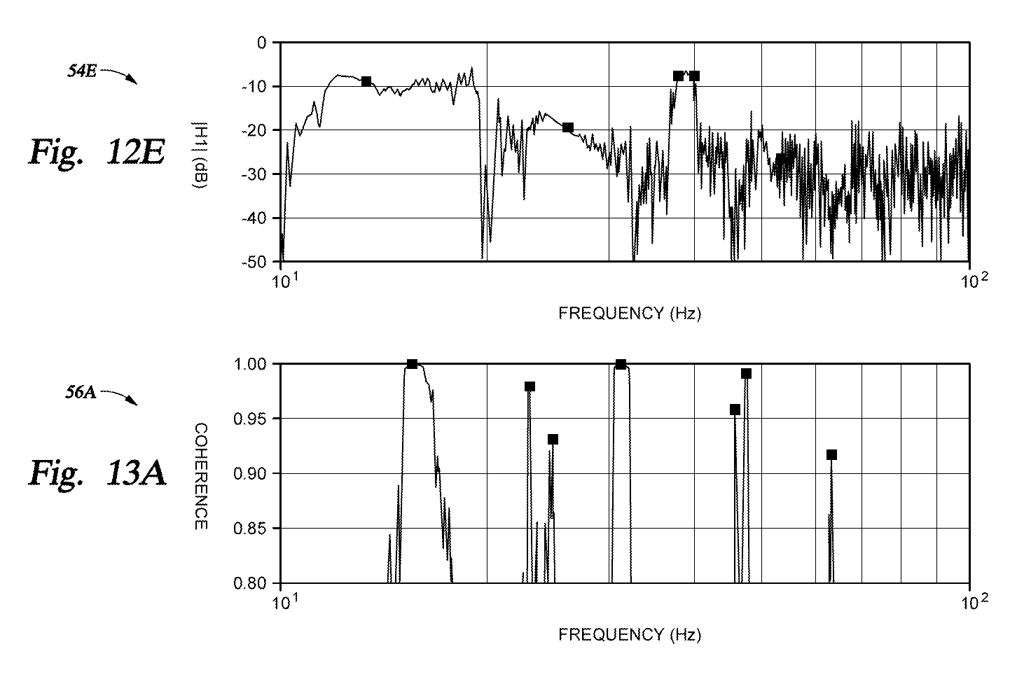

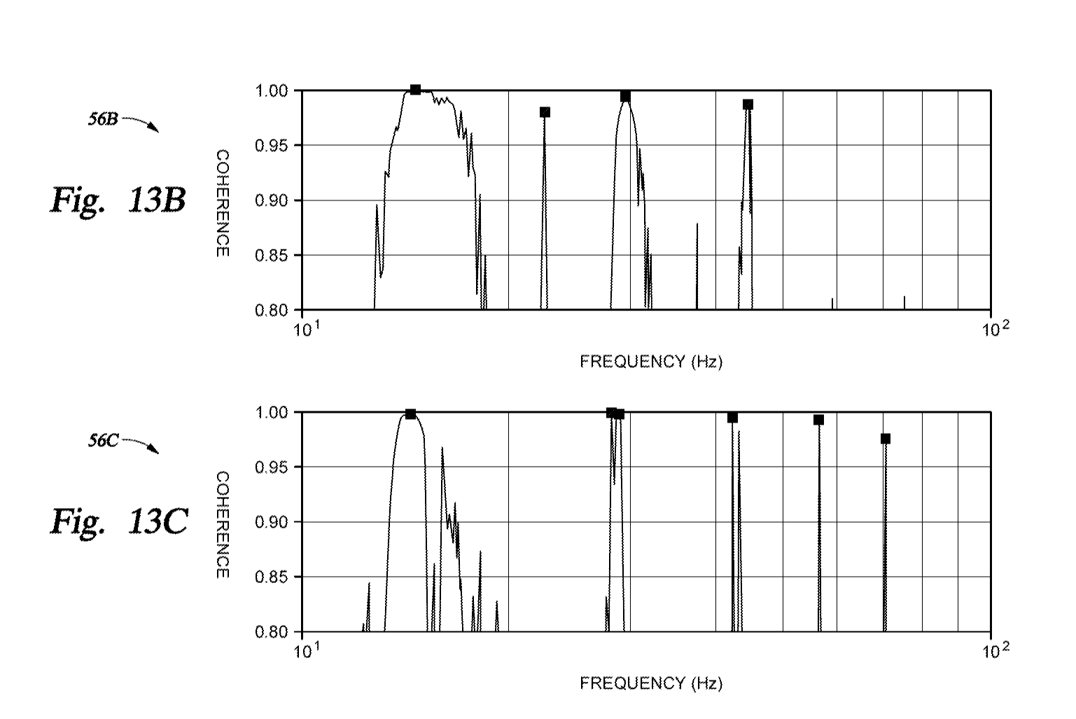

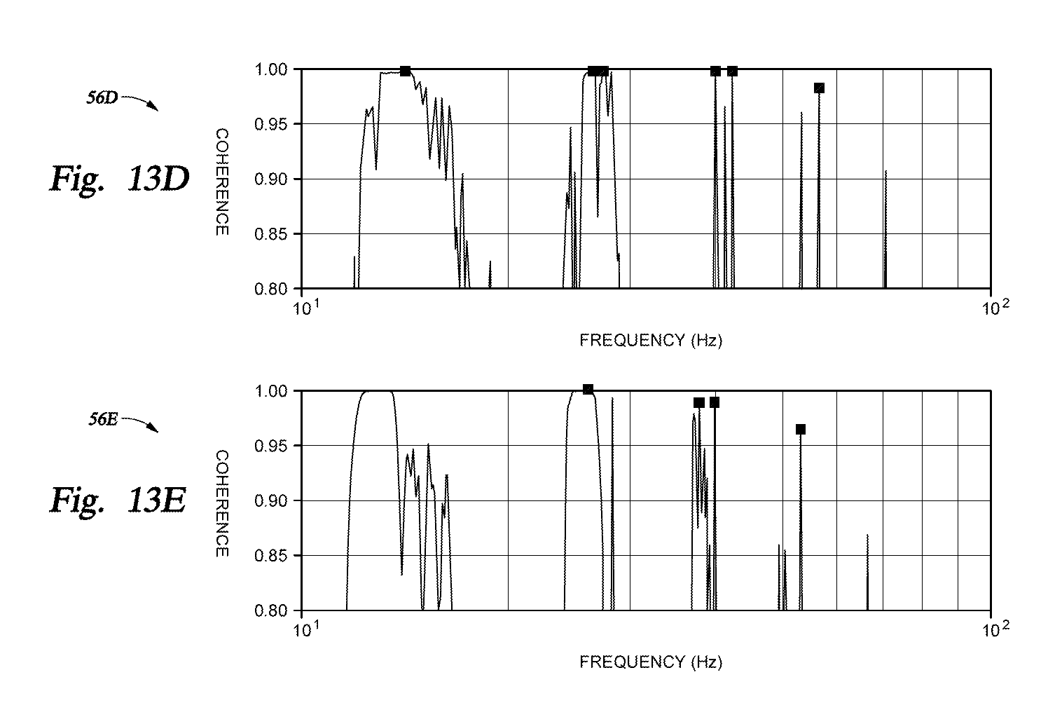

Transmissibility through the test medium is provided in the frequency response function plots 54A-54E of FIGS. 12A-12E. These plots 54A-54E compare the amount of vibration transferred through the medium and were obtained by comparing the values measured at the vibration source and the upper or treatment surface of the medium. Amplitude attenuation through the medium ranged from about 61% through 68%. Coherence plots 56A-56E are provided in FIGS. 13A-13E that confirm values for dominant frequencies illustrated in the response plots and show similar reductions in amplitude from the vibration source to the treatment surface of the medium. In FIGS. 12A-12B and 13A-13E, the measurements taken from the vibration source were along the vertical axis.

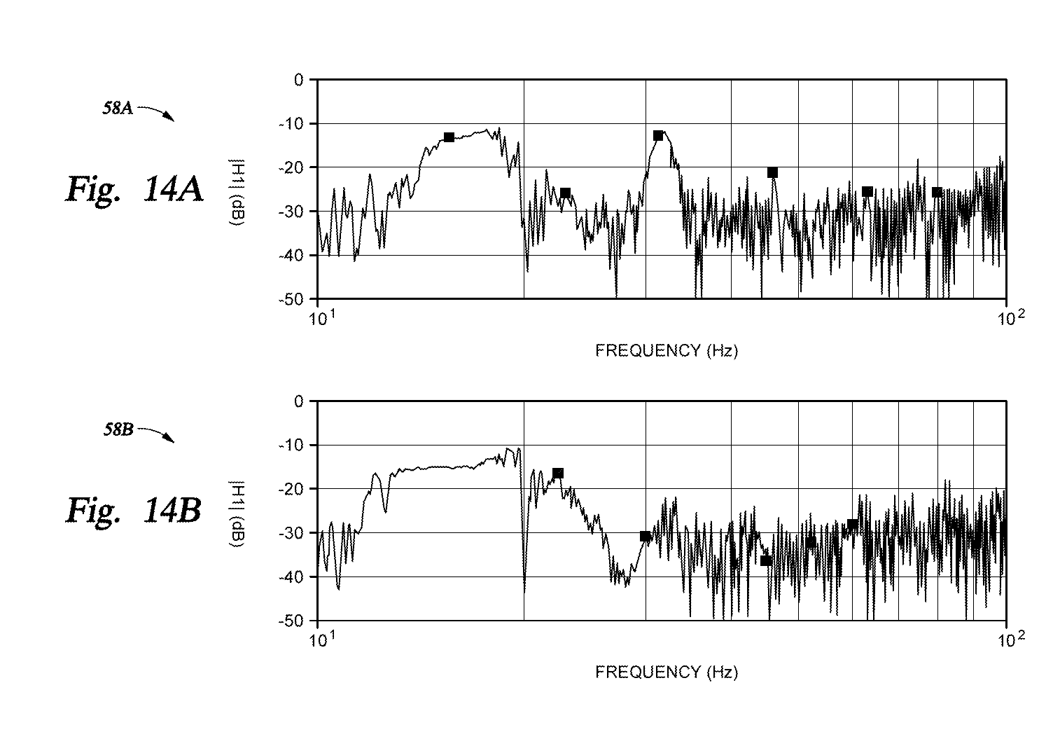

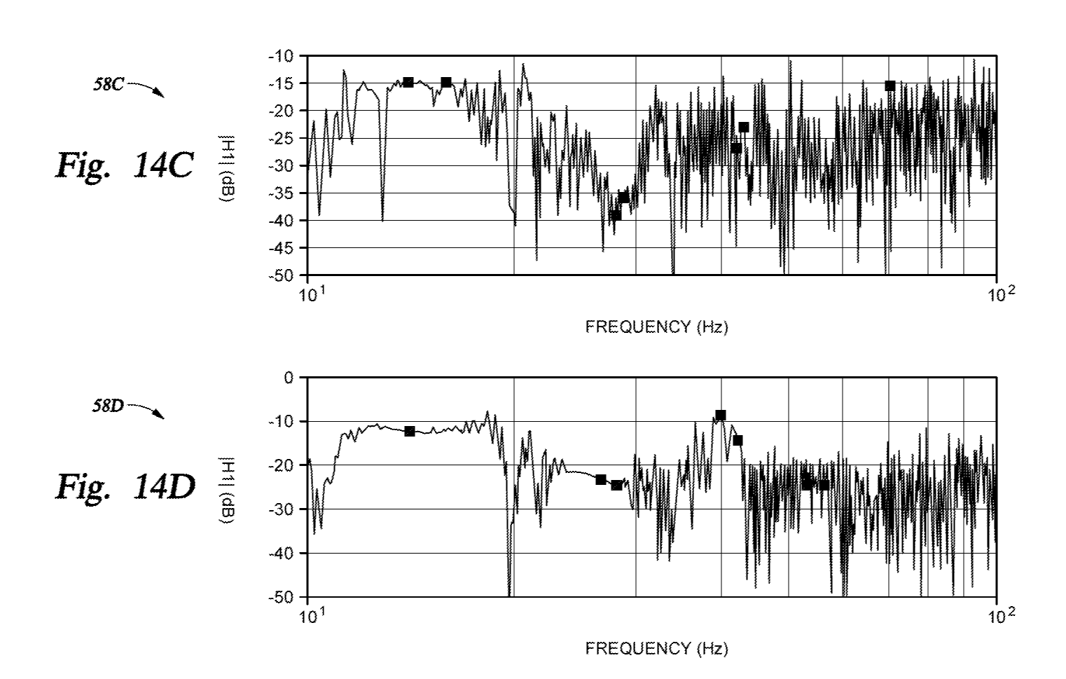

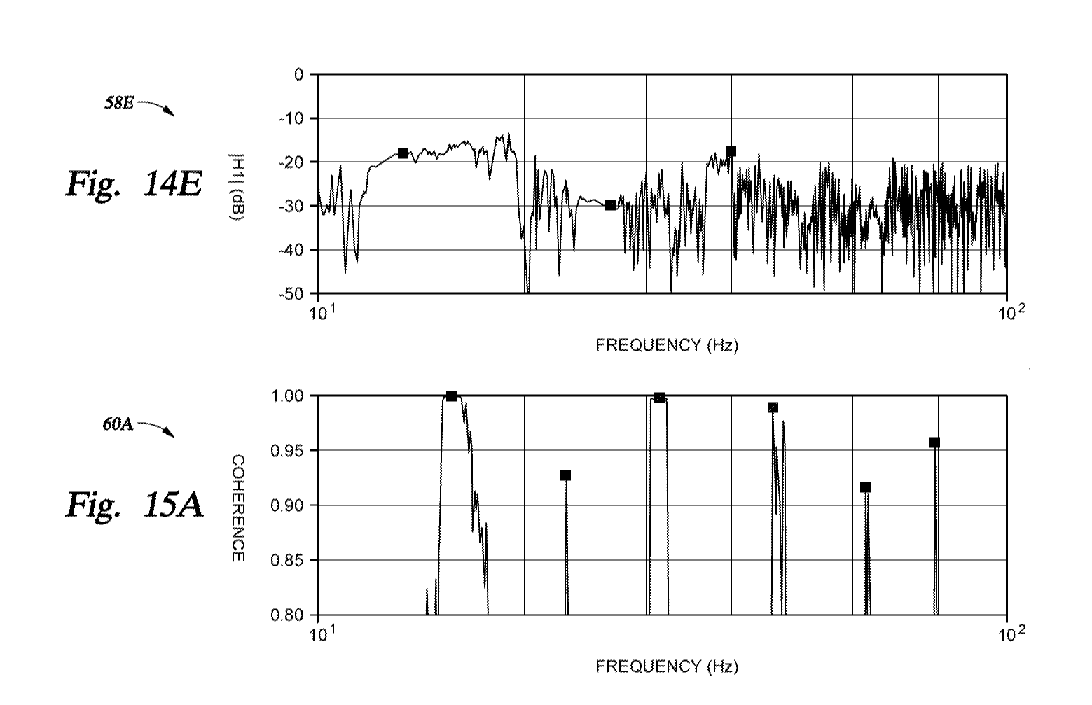

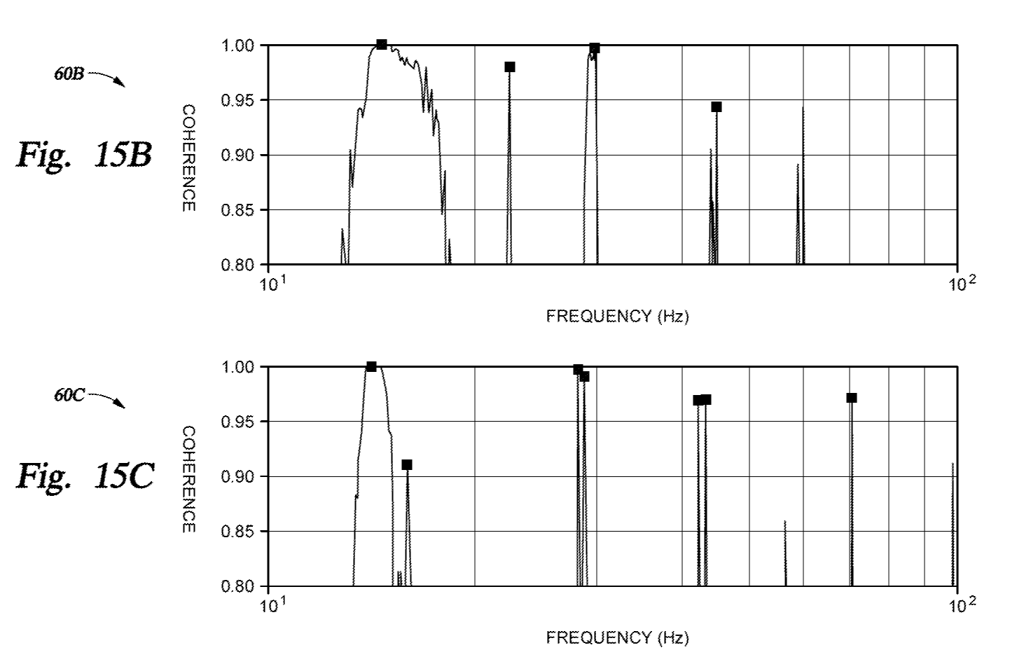

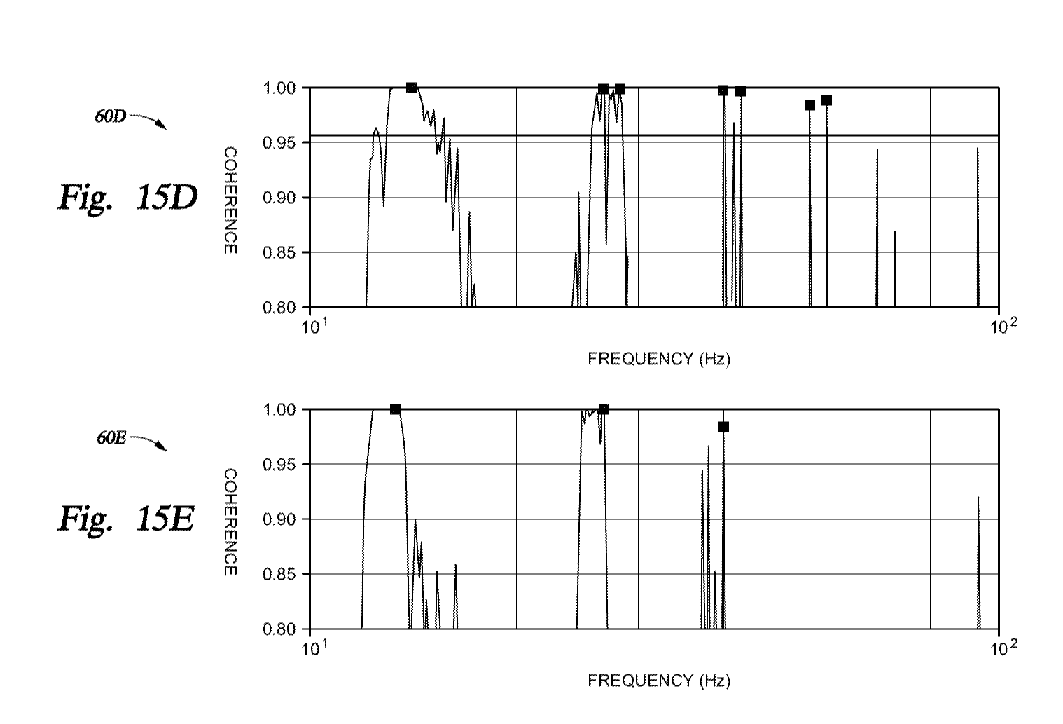

Shown in FIG. 14A is a frequency response function plot illustrating the signal transmission through the signal source to the treatment surface of the medium, wherein accelerometers were positioned on the medium at the locations as provided in FIG. 5A. Thus, plots 58A-58E respectively represent data recorded at the signal source and at respective accelerometers A₁-A₅, and coherence plots 60A-60E provided in FIGS. 15A-15E respectively, correspond to the frequency response function plots 58A-58E.

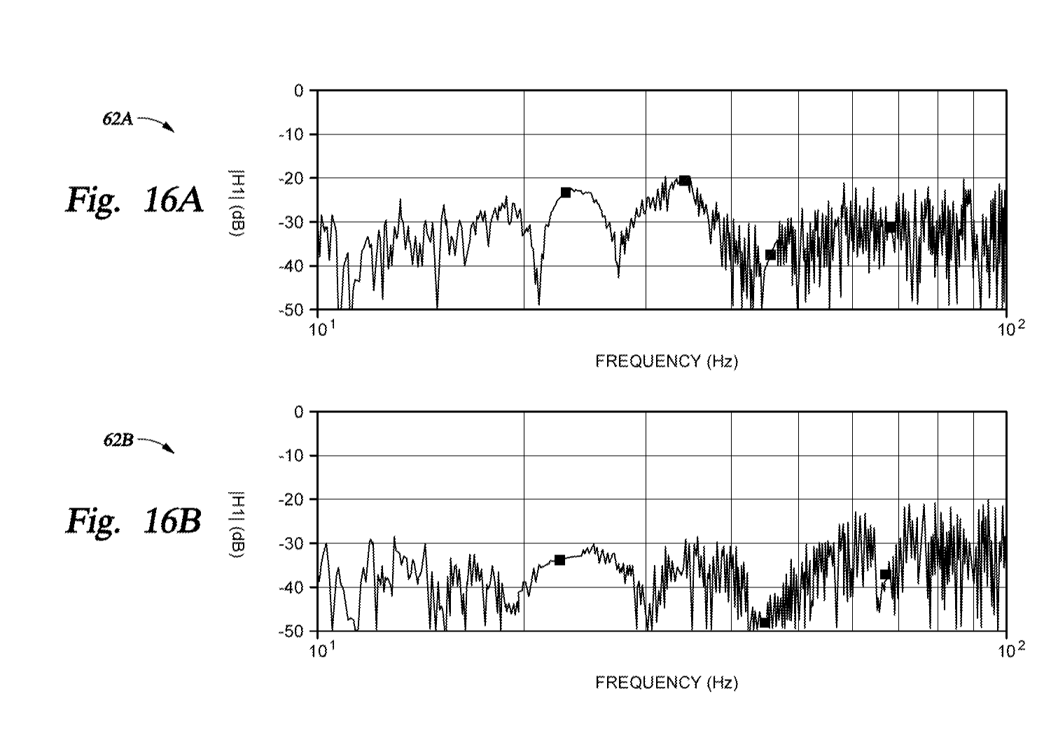

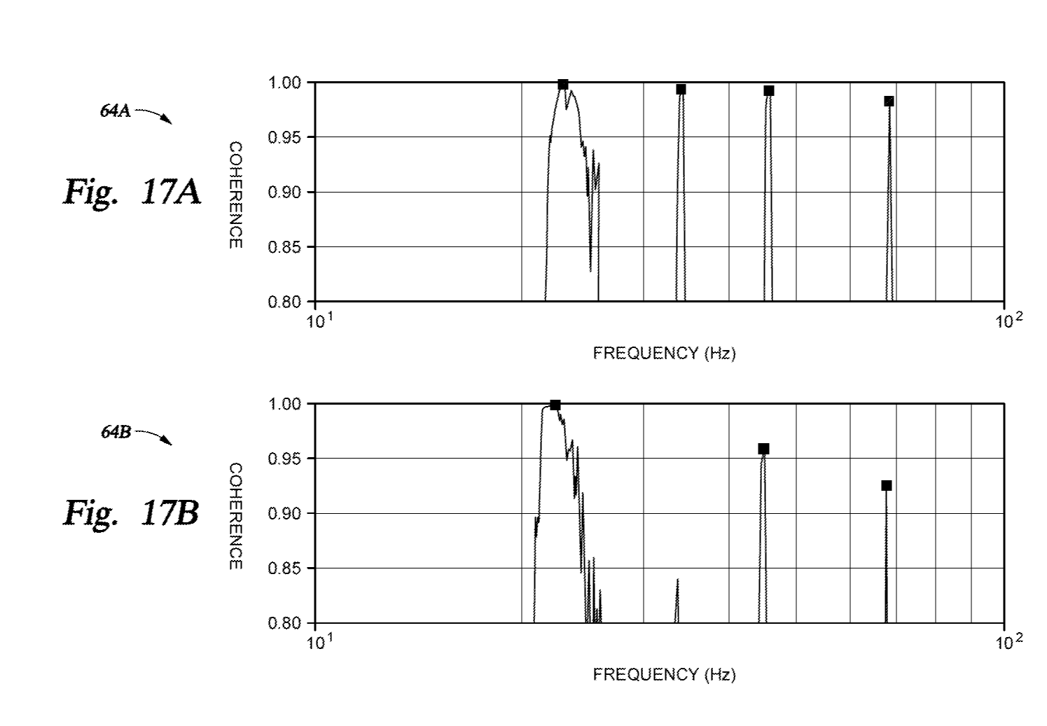

Additional data was recorded from the test setup of FIG. 6A that include the subject 38 set on the treatment surface 37. Data recorded with accelerometer A_{2A} was used to form the frequency response function plot 62A shown in FIG. 16A. Similarly, data recorded with accelerometer A_{1A} was used to form the frequency response function plot 62B shown in FIG. 16B. Shown in FIG. 62A is a fairly \veil defined single frequency at 22.82 Hz that transmits through the medium and roughly in the lumbar region of the subject. This is confirmed with the coherence plot 64A of FIG. 17A that corresponds to the plot 62A. In FIG. 62B, a single dominant frequency at 22.5 Hz is represented by the plot and confirmed with coherence plot 64B provided in FIG. 17B.

In one example of operation, a vibrating source 14, 14A, 14B (FIGS. 1-4) is set in close contact with a medium 12, such as a bed mattress, and positioned on a lower side so that when a subject 38 is recumbent on a treatment side 37 of the medium 12. Vibrational signals 27 (FIG. 4) propagate through the medium 12 and to a designated location 39 on the treatment side 37 of the medium 12. Strategically identifying the designated location 39 so that it is adjacent the lumbar region of the subject 38 can ensure transmissibility of the vibration signal into the subject with sufficient intensity to mask or mute signals from the bladder through the sacral nerve.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

1. A method of treating nocturia in a subject comprising:
providing a flexible medium having a treatment surface and on which a lumbar region of the object is disposed; and
transmitting a continuous vibratory signal in the medium on a side of the medium Apposite to the treatment surface that propagates to the treatment surface and oscillates a designated location on the treatment surface, so that when the designated location is placed into coupling contact with a lumbar region of the subject and external to the subject, the vibratory signal is transmitted from the designated location to a sacral nerve in the subject to mute a bladder control signal in the sacral nerve for at least the period of time the vibratory signal is transmitted to the sacral nerve.

2. The method of claim 1, wherein the flexible medium is a bed mattress that comprises a visco-elastic foam.

3. The method of claim 2, wherein the subject is in a state of suspended consciousness.

4. The method of claim 2, wherein the flexible medium further comprises a box spring for supporting the bed mattress.

5. The method of claim 1, wherein the treatment surface oscillates at a single dominant frequency that ranges from about 5 Hertz to about 150 Hertz.

6. The method of claim 1, wherein the treatment surface oscillates at a single dominant frequency that ranges from about 13 Hertz to about 15 Hertz.

7. The method of claim 1, further comprising providing a source for the vibratory signal that comprises an oscillating motor, producing the vibratory signal with the oscillating motor, and positioning the vibration source on a side of the medium opposite the treatment surface and substantially across from the designated location.

8. The method of claim 7, further comprising providing an adjustable frame for holding the oscillating motor in close contact with the medium.

9. The method of claim 7, wherein the vibratory signal when produced by the oscillating motor has more than one dominant frequency.

10. A device for treating nocturia in a subject comprising:
a flexible medium having a treatment surface with a designated location that is selectively put into contact with a lumbar region of a subject, and external to the subject, while a continuous vibratory signal is transmitted from the flexible medium to a sacral nerve in the subject for muting other signals in the sacral nerve; and
a vibratory signal source on a side of the flexible medium opposite the treatment surface for generating the continuous vibratory signal in the flexible medium that transmits into the lumbar region of the subject and into contact with a sacral nerve in the subject for muting other signals in the sacral nerve.

11. The device of claim 10, wherein the flexible medium comprises a visco-elastic foam.

12. The device of claim 10, wherein the flexible medium comprises a portion of a bed mattress on which the subject is recumbent.

13. The device of claim 10, wherein the flexible medium comprises a portion of a vehicle seat.

14. The device of claim 10, wherein the designated location oscillates from about 10 Hz to about 50 Hz.

15. The device of claim 10, wherein the designated location oscillates at about 13 Hz.

16. The device of claim 10, wherein the vibration source is selectively positioned on a side of the flexible medium opposite the treatment surface and directly to the lumbar region of the subject.

17. The device of claim 10, wherein the vibratory signal has a dominant single frequency when transmitted into the subject.
